(19) United States
(12) Patent Application Publication
(10) Pub. No.: US 2019/0071050 A1
(43) Pub. Date: Mar. 7, 2019

(54) VEHICLE AIRBAG SYSTEM

(71) Applicant: Ford Global Technologies, LLC, Dearborn, MI (US)

(72) Inventors: S.M. Iskander Farooq, Novi, MI (US); Saeed David Barbat, Novi, MI (US); Srinivasan Sundararajan, Ann Arbor, MI (US); Mohammad Omar Faruque, Ann Arbor, MI (US); Dean M. Jaradi, Macomb, MI (US); Nirmal Muralidharan, Birmingham, MI (US)

(73) Assignee: Ford Global Technologies, LLC, Dearborn, MI (US)

(21) Appl. No.: 15/697,392

(22) Filed: Sep. 6, 2017

(51) Int. Cl. B60R 21/36; B62D 25/04; B60R 13/04

(52) U.S. Cl. CPC B60R 21/36; B60R 2021/003; B60R 13/04; B62D 25/04

(57) ABSTRACT

A vehicle includes an A-pillar. The vehicle includes a windshield including an external surface and supported by the A-pillar. The vehicle includes an airbag inflatable from an uninflated position to an inflated position, the airbag in the uninflated position supported by the A-pillar, and the airbag in the inflated position including a first portion that extends along the A-pillar and abuts the external surface of the windshield and a second portion that extends transversely from the first portion.

### BACKGROUND

A vehicle may include an airbag deployable during a vehicle impact to absorb energy from a pedestrian outside of the vehicle during the impact. The airbag may be a component of an airbag assembly including a housing supporting the airbag, and an inflation device in communication with the airbag for inflating the airbag from an uninflated position to an inflated position.

### BRIEF DESCRIPTION OF THE DRAWINGS

FIG. 1 is a top perspective view of an example vehicle including an example airbag system with example airbags of the airbag system in uninflated positions.

FIG. 2 is a top view of the example vehicle with the example airbags of the example airbag system in the uninflated positions.

FIG. 3 is a cross section of a portion of the example vehicle.

FIG. 4 is a top perspective view of the example vehicle with example airbags of the example airbag system in inflated positions.

FIG. 5 is a top view of the example vehicle with the example airbags of the example airbag system in the inflated positions.

FIG. 6 is a block diagram of example components of the example vehicle.

### DETAILED DESCRIPTION

A vehicle includes an A-pillar. The vehicle includes a windshield including an external surface and supported by the A-pillar. The vehicle includes an airbag inflatable from an uninflated position to an inflated position, the airbag in the uninflated position supported by the A-pillar, and the airbag in the inflated position including a first portion that extends along the A-pillar and abuts the external surface of the windshield and a second portion that extends transversely from the first portion.

The A-pillar may include a body panel and a trim cover. The airbag in the uninflated position may be disposed between the body panel and the trim cover.

The vehicle may include a hood. The vehicle may have a longitudinal axis and the second portion of the airbag in the inflated position may extend along the hood along the longitudinal axis.

The vehicle may include a body panel adjacent the hood and having an external surface. The hood may include an external surface, and the second portion of the airbag in the inflated position may abut the external surface of the hood and the external surface of the body panel.

The vehicle may include a wheel well. The second portion of the airbag in the inflated position may extend to a location that is directly above the wheel well.

The vehicle of may include a hood. The vehicle may have a lateral axis and the second portion of the airbag in the inflated position may extend along the hood along the lateral axis.

The hood may include an external surface and the second portion of the airbag in the inflated position may abut the external surface of the hood.

The first portion may have an end and the second portion have an end. The vehicle may include a tether secured to the end of the first portion and to the end of the second portion.

The vehicle may include a hinge pillar and an inflator supported by one of the hinge pillar and the A-pillar and in communication with the airbag.

The vehicle may include a hood. The vehicle may have a lateral axis and a longitudinal axis, the airbag in the inflated position may include a third portion, the second portion may extend along the hood along the lateral axis, and the third portion may extend along the hood along the longitudinal axis.

The first portion, the second portion and the third portion may each include an end. The vehicle may include a first tether secured to the end of the first portion and to the end of the second portion, and a second tether secured to the end of the second portion and to the end of the third portion.

The A-pillar may have a width and the first portion of the airbag in the inflated position may have a width that is greater than the width of the A-pillar.

The vehicle may include a hood and a roof. The first portion of the airbag in the inflated position may extend between the hood and the roof.

The vehicle may include a cowl. The second portion of the airbag in the inflated position may extend along the cowl.

The cowl may have a width and the second portion of the airbag in the inflated position may have a width that is greater than the width of the cowl.

The vehicle may include a second A-pillar and a second airbag supported by the second A-pillar and inflatable to an inflated position in which the second airbag extends along the A-pillar and abuts the external surface of the windshield.

The airbag may abut the second airbag.

The second airbag in the inflated position may include a first portion that extends along the second A-pillar and abuts the external surface of the windshield and a second portion that extends transversely from the first portion.

The second portion of the second airbag may extend parallel to the second portion of the airbag.

The windshield and the A-pillar may define a gap, and the airbag in the uninflated position may be disposed in the gap.

With reference to the Figures, a vehicle 20 includes an A-pillar 22. The vehicle 20 includes a windshield 24 including an external surface 26 and supported by the A-pillar 22. The vehicle 20 includes an airbag 28 inflatable from an uninflated position to an inflated position. The airbag 28 in the uninflated position is supported by the A-pillar 22. The airbag 28 in the inflated position includes a first portion 30 that extends along the A-pillar 22 and abuts the external surface 26 of the windshield 24 and another portion, such as a second portion 32 and/or a third portion 34, that extends transversely from the first portion 30.

The airbags 28 in the inflated position can be impacted by a person outside the vehicle 20, i.e., a pedestrian, during an impact between the vehicle 20 and the pedestrian. The airbags 28 may absorb force from pedestrian contacting the A-pillar 22.

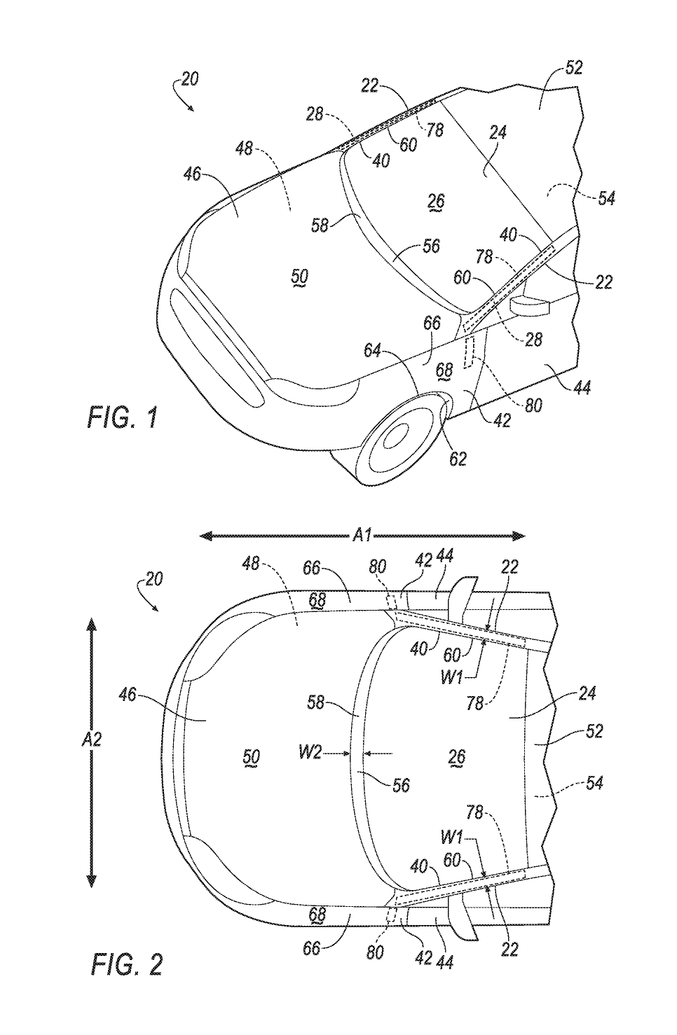

The vehicle 20, shown in FIGS. 1 through 6, may be any passenger or commercial automobile such as a car, a truck, a sport utility vehicle, a crossover vehicle, a van, a minivan, a taxi, a bus, etc.

The vehicle 20 has a longitudinal axis A1, as shown in FIG. 5. The longitudinal axis A1 extends between a front and a rear of the vehicle 20, e.g., parallel to a direction of travel of the vehicle 20 when the vehicle 20 is traveling straight.

The vehicle 20 has a lateral axis A2, as shown in FIG. 5. The lateral axis A2 extends crosswise between opposite sides of the vehicle 20, e.g., between a driver side and a passenger side. The lateral axis A2 is perpendicular to the longitudinal axis A1.

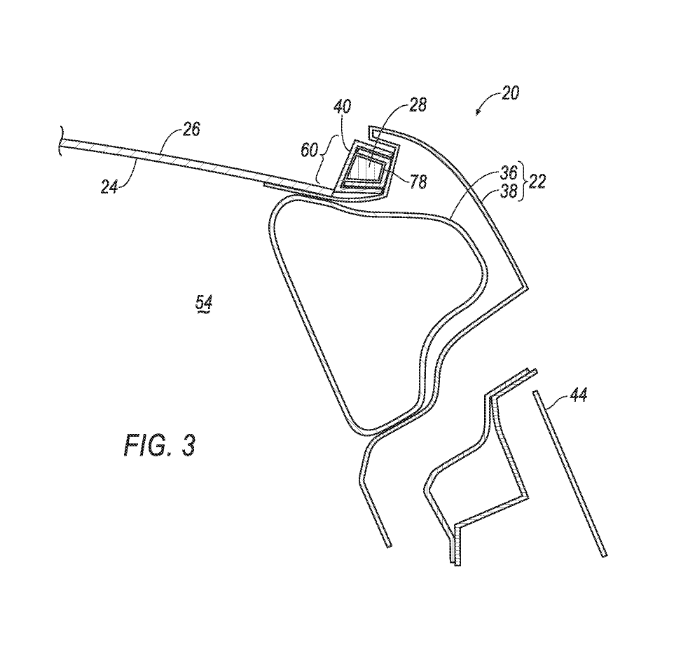

The vehicle 20 includes one or more A-pillars 22. Each A-pillar 22 may include a support column 36, a body panel 38, and a trim cover 40, as shown in FIG. 3. The body panel 38 and the trim cover 40 may have a class-A exterior surface, i.e., a surface specifically manufactured to have a high quality, finished aesthetic appearance free of blemishes. The body panel 38 and trim cover 40 may be supported by the support column 36. The body panel 38, the support column 36, and/or the trim cover 40 may be formed of any suitable material, for example, steel, aluminum, plastic, composite, etc.

The A-pillar 22 has a width W1, as shown in FIG. 2. The width W1 of the A-pillar 22 may be defined along the lateral axis A2.

The vehicle 20 may include a hinge pillar 42. The hinge pillar 42 may be located adjacent an opening in the vehicle 20 configured to permit entry and egress of occupants to and from the vehicle 20. The hinge pillar 42 may support a door 44 covering such opening. The hinge pillar 42 may be formed of any suitable material, for example, steel, aluminum, etc.

The A-pillar 22 and the hinge pillar 42 may be components of a unibody construction of the vehicle 20 which serves as a frame of the vehicle 20.

The vehicle 20 may include a hood 46. The hood 46 provides covering and protection to components of the vehicle 20, for example, the hood 46 may cover an engine compartment 48 and protect an engine, a radiator, and/or other components located therein. The hood 46 includes an external surface 50. The external surface 50 of the hood 46 may be a class-A exterior surface. The hood 46 may be formed of any suitable material, for example, steel, aluminum, etc.

The vehicle 20 may include a roof 52. The roof 52 may be located at a top of the vehicle 20. The roof 52 provides covering and protection to a passenger cabin 54 of the vehicle 20, as well as to occupants of the vehicle 20 seated therein. The roof 52 may be formed of any suitable material, for example, steel, aluminum, etc.

The vehicle 20 may include a cowl 56. The cowl 56 supports various vehicle 20 components such as the hood 46, the windshield 24, a dashboard, an instrument panel, etc. The cowl 56 may be located between the passenger cabin 54 and the engine compartment 48. The cowl 56 has a width W2, as shown in FIG. 2. The width W2 of the cowl 56 may be along the longitudinal axis A1. The cowl may include an external surface 58.

The vehicle 20 includes the windshield 24. The windshield 24 protects occupants of the vehicle 20, e.g., from wind, rain, bugs, etc. The windshield 24 is transparent, e.g., to permit the occupants to see therethrough. The windshield 24 may be formed of any suitable material, e.g., glass, plastic, laminate, etc. The windshield 24 includes the external surface 26. The external surface 26 is located outside of the passenger cabin 54 of the vehicle 20. The windshield 24 may extend from one A-pillar 22 to the other A-pillar 22. The windshield 24 may extend from the cowl 56 to the roof 52. The windshield 24 is supported by the A-pillars 22. The windshield 24 may be secured to the A-pillars 22, e.g., with an adhesive.

The windshield 24 and the A-pillar 22 may define a gap 60, as shown in FIGS. 1 through 3. The gap 60 may be a slot that is elongated along the A-pillar 22, e.g., between the cowl 56 and the roof 52.

The vehicle 20 includes one or more wheel wells 62. The wheel wells 62 protect and cover wheels of the vehicle 20. Each of the wheel wells 62 may have an arcuate shape. Each of the wheel wells 62 may define an apex 64, i.e., a top most location of the wheel well 62.

The vehicle 20 includes one or more body panels 66 other than the body panels 38 of the A-pillars 22. Such body panels 66 cover and protect various components of the vehicle 20. For example, one of the body panels 66 may be located adjacent the hood 46 and one of the wheel wells 62. Such body panel 66 may cover and protect the hinge pillar 42. Each of the body panels 66 may have an external surface 68. The external surface 68 of each body panel 66 may be a class-A surface. The body panels 66 may be formed of any suitable material, for example, steel, aluminum, etc.

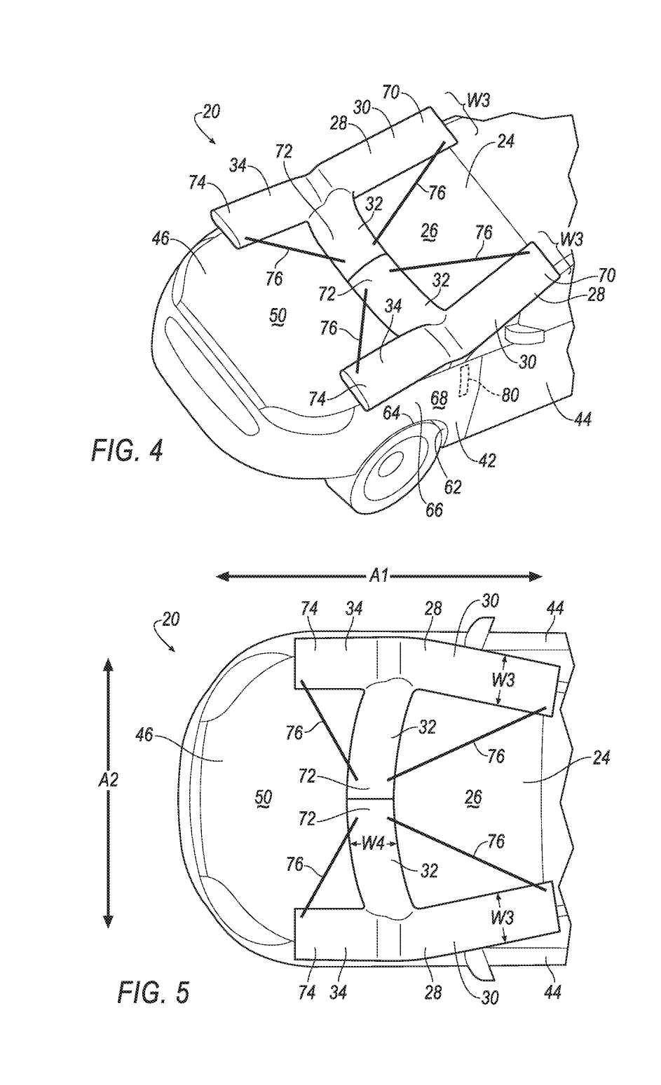

The vehicle 20 may include one or more airbags 28. Each of the airbags 28 are inflatable from the uninflated position, shown in FIGS. 1 through 3, to the inflated position, shown in FIGS. 4 and 5.

The airbags 28 may be formed of a woven polymer or any other material. As one example, the airbags 28 may be formed of woven nylon yarn, for example, nylon 6-6. Other examples include polyether ether ketone (PEEK), polyetherketoneketone (PEKK), polyester, etc. The woven polymer may include a coating, such as silicone, neoprene, urethane, etc. For example, the coating may be polyorgano siloxane.

Each of the airbags 28 in the uninflated positions are supported by one of the A-pillars 22. For example, each of the airbags 28 in the uninflated position may be disposed between the body panel 38 of one of the A-pillars 22 and the trim cover 40 of such A-pillar 22. For example, each of the airbags 28 in the uninflated positions may be disposed in the gap 60 defined by one of the A-pillars 22 and the windshield 24.

Each of the airbags 28 in the inflated positions include the first portion 30. The first portion 30 extends along the A-pillar 22 and abuts the external surface 26 of the windshield 24. For example, the first portion 30 may be elongated along the A-pillar 22 and extend between the hood 46 and the roof 52.

The first portion 30 has an end 70. The end 70 is spaced from where the first portion 30 meets the second portion 32 and/or the third portion 34.

The first portion 30 of each of the airbags 28 in the inflated positions has a width W3, as shown in FIG. 5. The width W3 of the first portion 30 may be defined along the lateral axis A2. The width W3 of the first portion 30 may be greater than the width W1 of the A-pillar 22.

Each of the airbags 28 in the inflated positions may include the second portion 32. The second portion 32 extends transversely from the first portion 30. Each of the second portions 32 may have an end 72. The end 72 of the second portion 32 is spaced from where the second portion 32 meets the first portion 30. The first portion 30 and the second portion 32 may be in fluid communication, enabling fluid to flow between the first portion 30 and the second portion 32.

The second portion 32 of one of the airbags 28 may extend parallel to the second portion 32 of the other airbag 28. For example, the second portion 32 of each of the airbags 28 may be elongated in a same direction.

The second portion 32 of the airbag 28 in the inflated position may extend along the hood 46 along the lateral axis A2. For example, the second portion 32 may extend from the first portion 30 where the A-pillar 22 meets the hood 46 and be elongated along the lateral axis A2. The second portion 32 of the airbag 28 in the inflated position may abut the external surface 50 of the hood 46.

The second portion 32 of the airbag 28 in the inflated position may extend along the cowl 56. For example, the second portion 32 may extend from the first portion 30 where the A-pillar 22 meets the cowl 56 and be elongated along the lateral axis A2. The second portion 32 of the airbag 28 in the inflated position may abut the external surface 58 of the cowl 56.

The second portion 32 of the airbag 28 in the inflated position has a width W4, as shown in FIG. 5. The width W4 of the second portion 32 may be defined along the longitudinal axis A1. The width W4 of the second portion 32 may be greater than the width W2 of the cowl 56.

Each of the airbags 28 in the inflated positions may include the third portion 34. The third portion 34 extends transversely from the first portion 30. Each of the third portions 34 may have an end 74. The end 74 of the third portion 34 is spaced from where the third portion 34 meets the first portion 30. The first portion 30 and the third portion 34 may be in fluid communication, enabling fluid to flow between the first portion 30 and the third portion 34.

The third portion 34 of the airbag 28 in the inflated position may extend along the hood 46 along the longitudinal axis A1. For example, the third portion 34 may extend from first portion 30 where the A-pillar 22 meets the hood 46 and be elongated along longitudinal axis A1. The third portion 34 may be elongated along where the hood 46 meets one of the body panels 66. The third portion 34 of the airbag 28 in the inflated position may abut the external surface 50 of the hood 46 and the external surface 68 of one of the body panels 66. The third portion 34 of the airbag 28 in the inflated position may extend to a location that is directly above the wheel well 62. For example, the end 74 of the third portion 34 of one of the airbags 28 in the inflated position may be located directly above the apex 64 of the wheel well 62.

One of the airbags 28 in the inflated position may abut another of the airbags 28 in the inflated position. For example, the end 72 of the second portion 32 of one of the airbags 28 may abut the end 72 of the second portion 32 of the other of the airbags 28, as shown in FIGS. 4 and 5. The airbags 28 may abut each other above the cowl 56.

The first portions 30, the second portions 32, and the third portions 34 of the airbags 28 in the inflated positions may together define an H-shape, as shown in FIGS. 4 and 5. The H-shape of the airbags 28 may cover the A-pillars 22, the cowl 56, and where the hood 46 meets the body panels 66.

The vehicle 20 may include one or more tethers 76. The tethers 76 may be made of any suitable material, for example, the tethers 76 may be made of a same type of material as the airbags 28.

One of the tethers 76 may be secured to the end 70 of the first portion 30 and to the end 72 of the second portion 32 of one of the airbags 28. Another of the tethers 76 may be secured to the end 72 of the second portion 32 and to the end 74 of the third portion 34 of one of the airbags 28. The tethers 76 may be secured to the various portions 30, 32, 34 with stitching, adhesive, etc.

The vehicle 20 may include one or more airbag 28 housings 78. Each housing 78 may contain one of the airbags 28 in the uninflated positions. Each housing 78 provides a reaction surface for the airbag 28 in the inflated position. Each housing 78 may be supported by one of the A-pillars 22. For example, each housing 78 may be disposed in one of the gaps 60 defined by the windshield 24 and one of the A-pillars 22. For example, each housing 78 may be disposed between the trim cover 40 and the body panel 38 of one of the A-pillars 22. The housings 78 may be formed of any material, e.g., a rigid polymer, a metal, a composite, etc.

The vehicle 20 may include one or more inflator 80. Each inflator 80 may be in fluid communication with one or more of the airbags 28, e.g., directly, through various piping, etc. The inflator 80 may be, for example, a pyrotechnic inflator that uses a chemical reaction to drive inflation medium to the airbag 28. The inflator 80 may be of any suitable type, for example, a cold-gas inflator. Each inflator 80 may be supported by one of the hinge pillars 42. Each inflator 80 may be supported by one of the A-pillars 22. Each inflator 80 may be supported by a combination thereof, or in any other suitable location on the vehicle 20. Each inflator 80 may be supported by one of the housings 78.

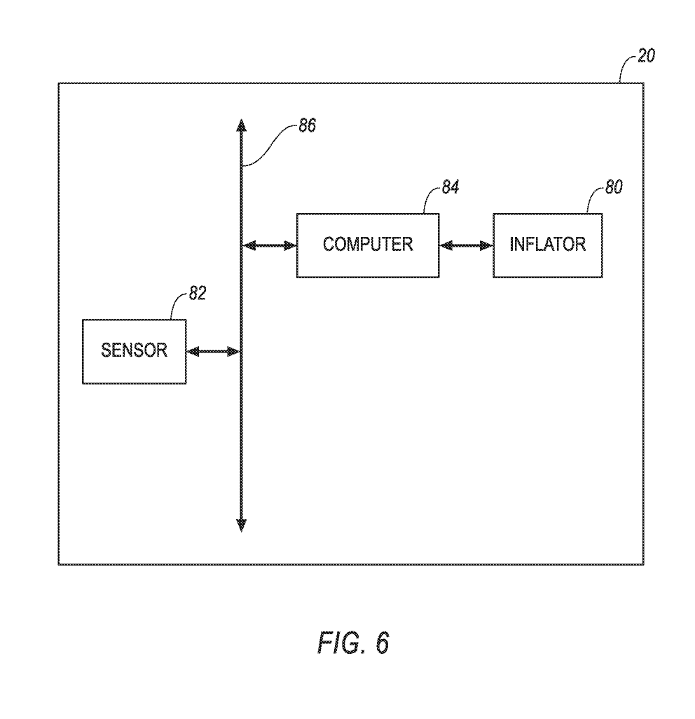

The vehicle 20 may include at least one impact sensor 82 for sensing impact of the vehicle 20, and a computer 84 in communication with the impact sensor 82 and the inflators 80, as shown in FIG. 6. The computer 84 may activate the inflators 80, e.g., provide an impulse to a pyrotechnic charge of the inflators 80 when the impact sensor 82 senses an impact of the vehicle 20. Alternatively or additionally to sensing impact, the impact sensor 82 may be configured to sense impact prior to impact, i.e., pre-impact sensing.

The impact sensor 82 may be in communication with the computer 84. The impact sensor 82 is configured to detect an impact to the vehicle 20. The impact sensor 82 may be of any suitable type, for example, post-contact sensors such as accelerometers, pressure sensors, and contact switches; and pre-impact sensors such as radar, LIDAR, and vision-sensing systems. The vision-sensing systems may include one or more cameras, CCD image sensors, CMOS image sensors, etc. The impact sensor 82 may be located at numerous points in or on the vehicle 20.

The computer 84 and the impact sensor 82 may be connected to a communication bus 86, such as a controller area network (CAN) bus, of the vehicle 20. The computer 84 may use information from the communication bus 86 to control the activation of the inflators 80. The inflators 80 may be connected directly to the computer 84, as shown in FIG. 6, or the inflators 80 may be connected via the communication bus 86.

The computer 84 may be a microprocessor-based computer 84 implemented via circuits, chips, or other electronic components. For example, the computer 84 may include a processor, a memory, etc. The memory of the computer 84 may include memory for storing programming instructions executable by the processor as well as for electronically storing data and/or databases.

In operation, the airbags 28 of the vehicle 20 are in the uninflated positions under normal operating conditions of the vehicle 20. In the event of an impact, the impact sensor 82 may detect the impact and transmit a signal through the communication bus 86 to the computer 84. The computer 84 may transmit a signal through the communication bus 86 to each of the inflators 80. Upon receiving the signals, the inflators 80 may discharge and inflate the airbags 28 with the inflation medium from the uninflated positions to the inflated positions.

The adjectives “first,” “second,” and “third” are used throughout this document as identifiers and are not intended to signify importance or order.

The preposition “along” is used through this document to mean having a same contour as a line and/or surface of a subject used therewith. For example, along an axis means parallel to such axis, including being spaced from such axis.

It is to be understood that the various geometric descriptions of the airbags, e.g., extending along an axis, etc., are limited in their precision by the flexible nature of the airbags in the inflated positions.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A vehicle comprising:
an A-pillar;
a windshield including an external surface and supported by the A-pillar; and
an airbag inflatable from an uninflated position to an inflated position, the airbag in the uninflated position supported by the A-pillar, and the airbag in the inflated position including a first portion that extends along the A-pillar and abuts the external surface of the windshield and a second portion that extends transversely from the first portion.

2. The vehicle of claim 1, wherein the A-pillar includes a body panel and a trim cover, wherein the airbag in the uninflated position is disposed between the body panel and the trim cover.

3. The vehicle of claim 1, further comprising a hood, wherein the vehicle has a longitudinal axis and the second portion of the airbag in the inflated position extends along the hood along the longitudinal axis.

4. The vehicle of claim 3, further comprising a body panel adjacent the hood and having an external surface, wherein the hood includes an external surface, and the second portion of the airbag in the inflated position abuts the external surface of the hood and the external surface of the body panel.

5. The vehicle of claim 3, further comprising a wheel well, wherein the second portion of the airbag in the inflated position extends to a location that is directly above the wheel well.

6. The vehicle of claim 1, further comprising a hood, wherein the vehicle has a lateral axis and the second portion of the airbag in the inflated position extends along the hood along the lateral axis.

7. The vehicle of claim 6, wherein the hood includes an external surface and the second portion of the airbag in the inflated position abuts the external surface of the hood.

8. The vehicle of claim 1, wherein the first portion has an end and the second portion has an end, and further comprising a tether secured to the end of the first portion and to the end of the second portion.

9. The vehicle of claim 1, further comprising a hinge pillar and an inflator supported by one of the hinge pillar and the A-pillar and in communication with the airbag.

10. The vehicle of claim 1, further comprising a hood, wherein the vehicle has a lateral axis and a longitudinal axis, the airbag in the inflated position includes a third portion, the second portion extends along the hood along the lateral axis, and the third portion extends along the hood along the longitudinal axis.

11. The vehicle of claim 10, wherein the first portion, the second portion and the third portion each include an end, and further comprising a first tether secured to the end of the first portion and to the end of the second portion, and a second tether secured to the end of the second portion and to the end of the third portion.

12. The vehicle of claim 1, wherein the A-pillar has a width and the first portion of the airbag in the inflated position has a width that is greater than the width of the A-pillar.

13. The vehicle of claim 1, further comprising a hood and a roof, wherein the first portion of the airbag in the inflated position extends between the hood and the roof.

14. The vehicle of claim 1, further comprising a cowl, wherein the second portion of the airbag in the inflated position extends along the cowl.

15. The vehicle of claim 14, wherein the cowl has a width and the second portion of the airbag in the inflated position has a width that is greater than the width of the cowl.

16. The vehicle of claim 1, further comprising a second A-pillar and a second airbag supported by the second A-pillar and inflatable to an inflated position in which the second airbag extends along the A-pillar and abuts the external surface of the windshield.

17. The vehicle of claim 16, wherein the airbag abuts the second airbag.

18. The vehicle of claim 16, wherein the second airbag in the inflated position includes a first portion that extends along the second A-pillar and abuts the external surface of the windshield and a second portion that extends transversely from the first portion.

19. The vehicle of claim 18, wherein the second portion of the second airbag extends parallel to the second portion of the airbag.

20. The vehicle of claim 1, wherein the windshield and the A-pillar define a gap, and the airbag in the uninflated position is disposed in the gap.
